(19) United States
(12) Patent Application Publication
(10) Pub. No.: US 2008/0275791 A1
(43) Pub. Date: Nov. 6, 2008

(54) System for managing inventory

(76) Inventors: Ayman Adib Youssef, Hopkinton, MA (US); Moneer Guirguis, Natick, MA (US)

Correspondence Address: KRIEGSMAN & KRIEGSMAN, 30 TURNPIKE ROAD, SUITE 9, SOUTHBOROUGH, MA, 01772, US

(21) Appl. No.: 12/150,850

(22) Filed: May 1, 2008

Related U.S. Application Data
(60) Provisional application No. 60/927,216, filed on May 1, 2007.

(51) Int. Cl. G06Q 30/00

(52) U.S. Cl. 705/26

(57) ABSTRACT

A system for managing customer inventory includes a plurality of customers which electronically communicate with a plurality of vendors through a server located at a centralized hub. A retrievable look-up table is utilized by the server to limit communication to only those customers and vendors that have an authorized business relationship. Each customer includes an inventory of items, the inventory level being self-monitored by the customer. When a particular product is required, the customer transmits a purchase order to the server using a handheld compute device which is then forwarded to the vendor designated in the purchase order. In addition, each vendor is capable of sending real-time information, such as product updates and purchase order reminders, to the server which is in turn sent to the handheld device for each customer with which it has an authorized relationship.

### CROSS-REFERENCE TO RELATED APPLICATIONS

The present application claims the benefit under 35 U.S.C. 119(e) of U.S. provisional Patent Application Ser. No. 60/927,216, filed May 1, 2007, the disclosure of which is incorporated herein by reference.

### BACKGROUND OF THE INVENTION

The present invention relates generally to the field of inventory control and more particularly to the management of inventory for small-sized retail stores.

Many small-sized retail stores (e.g., convenience stores, gas stations, liquor stores, etc.) offerforsale a wide range of different products (e.g., soft drinks, alcoholic beverages, cigarettes, etc.) to their customers. Due to the considerable difference in the types of products that it typically offers, each retail store (also referred to herein simply as a retailer) commonly engages in repeated business dealings with a plurality of different vendors, with each vendor responsible for supplying the retailer with particular items. For example, the retailer may use one vendor to supply its store with dairy products, another vendor to supply its store with cigarettes and another vendor to supply its store with soft drinks. As a consequence, a single retailer may utilize dozens of different vendors to supply its store with an adequate amount of inventory.

Vendors often assume the responsibility of managing the inventory of products in smaller-sized retail stores. Specifically, a sales representative for the vendor is typically assigned to routinely visit the retailer and visually inspect the inventory of products that it supplies to the store. If the supply of a certain product requires replenishing, the sales representative requests permission from the retailer to execute an order to deliver an additional supply of the product to maintain proper inventory levels.

A handheld compute device is often utilized by the sales representative to simplify the process of placing the supply order. Specifically, the sales representative first enters into the compute device the unique identification code associated with the particular retailer. The sales representative then locates the specific product that requires replenishing (e.g., a particular brand of cigarettes) and enters the identification code associated with the product into the compute device (e.g., by scanning a barcode provided on the packaging for the item). With the product identified, the sales representative enters the amount of the product that needs to be ordered. Once completed, the particulars associated with the order are transmitted back to a distribution center for the vendor (e.g., using wireless/cellular transmission techniques), thereby completing the order placing process.

It has been found that the above-described process for placing a supply order introduces a couple notable shortcomings.

As a first shortcoming, the above-described process is often inconvenient and bothersome for the retailer. Specifically, as noted above, a single retailer often utilizes dozens of different vendors. As a result, a retailer is often required to interact with a large number of different sales representatives each week. As can be appreciated, this time requirement has been found to be notably cumbersome for smaller-staffed retailers that have a considerable customer base.

As a second shortcoming, the above-described process is relatively expensive for each vendor. Specifically, each vendor is often required to employ both (i) sales representatives who are responsible for, among other things, routinely visiting the retailer to monitor, assess and maintain proper inventory levels within the store and (ii) in-house operators who are responsible for, among other things, entering and overseeing the execution of a supply order (e.g., by manually inputting each supply order into their database). As can be appreciated, the costs associated with the employment of sales representatives and in-house operators are exclusively borne by the vendor which, in turn, increases its overall operating costs, which is highly undesirable.

### SUMMARY OF THE INVENTION

It is an object of the present invention to provide a system for managing customer inventory.

It is another object of the present invention to provide a system for managing customer inventory without the use of vendor sales representatives.

It is yet another object of the present invention to provide a system for managing customer inventory which permits the customer to self-monitor inventory levels.

It is still another object of the present invention to provide a system for managing customer inventory which permits a customer to create and transmit a supply order to a designated vendor to replenish inventory levels.

Accordingly, as one feature of the present invention, there is provided a system for managing inventory, the system comprising (a) a plurality of customers, each customer comprising an inventory of items, (b) a plurality of vendors, each vendor comprising at least one product available for purchase by the plurality of customers, and (c) a server in electronic communication with the plurality of customers and the plurality of vendors, (d) wherein the server is provided with a modifiable lookup table which cross-references which of the plurality of vendors has an authorized business relationship with each customer, the server limiting electronic communication between the plurality of customers and plurality of vendors to only those relationships set forth as authorized on the lookup table.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a simplified block diagram of a system for managing customer inventory, the system being constructed according to the teachings of the present invention;

FIG. 2 is a sample look-up table stored in the server shown in FIG. 1, the look-up table cross-referencing which of the vendors has an authorized business relationship with each customer; and

FIGS. 3(a)-(d) are a series of sample screen displays from one of the handheld, wireless compute devices shown in FIG. 1, the sample screen displays being useful in understanding the process by which a customer places a purchase order with an authorized vendor.

### DETAILED DESCRIPTION OF THE PREFERRED EMBODIMENT

### System for Managing Customer Inventory

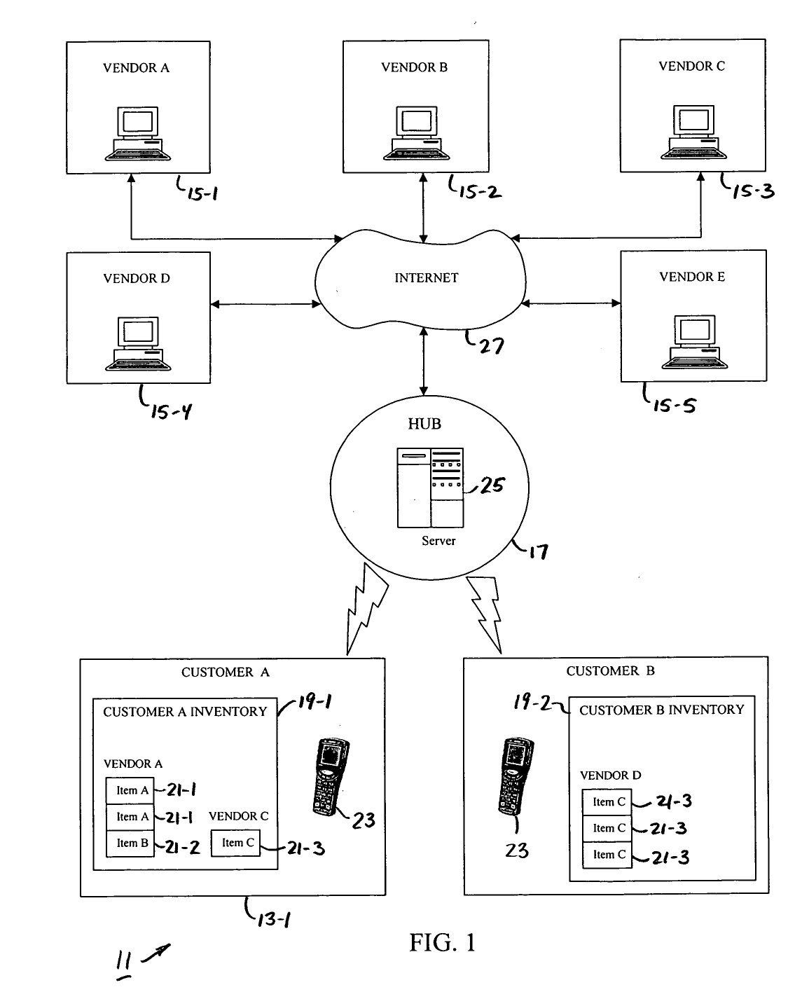

Referring now to FIG. 1, there is shown a novel system for managing customer inventory, the system being described according to the teachings of the present invention and identified generally by reference numeral 11. As will be described in detail below, system 11 enables a customer to both (i) self-monitor inventory levels and (ii) wirelessly transmit a supply order for a particular product to a designated vendor, thereby eliminating the need for traditional vendor sales representatives, which is a principal object of the present invention.

System 11 comprises a plurality of customers 13 which electronically communicate with a plurality of vendors 15 through a central hub 17.

System 11 is shown herein comprising a pair of customers 13-1 and 13-2. As defined herein, each customer 13 represents any entity that maintains an inventory of different items. For example, each customer 13 may represent a small-sized retail store that maintains an inventory of different items for sale (e.g., a convenience store, gas station, liquor store, etc.). As another example, each customer 13 may represent an office-based business that maintains an inventory of different office products for use in conjunction with its operations (e.g., an accounting firm, marketing firm, etc.).

It should be noted that system 11 is not limited to any particular number of customers 13. Rather, it is to be understood that the number of customers 13 participating in system 11 could be increased or decreased without departing from the spirit of the present invention.

Each customer 13 is shown comprising an inventory 19 of items 21. Specifically, customer 13-1 (also identified in FIG. 1 as customer A) comprises an inventory 19-1 which includes a pair of first items 21-1 (also identified in FIG. 1 as items A), a single second item 21-2 (also identified in FIG. 1 as item B) and a single third item 21-3 (also identified in FIG. 1 as item C). As represented in FIG. 1, items A and B were purchased by customer A from a particular vendor (namely, vendor A), whereas item C was purchased by customer A from an entirely different vendor (namely, vendor C).

Similarly, customer 13-2 (also identified in FIG. 1 as customer B) comprises an inventory 19-2 which consists of three items 21-3. However, it should be noted that customer 13-2 purchased each item C from a different vendor (i.e., vendor D) than the vendor (i.e., vendor C) from which customer 13-1 purchased its item C, since multiple, different vendors 15 may offer the same products for sale.

Each customer 13 is also preferably equipped with a handheld, programmable compute device 23. Preferably, compute device 23 includes a display screen (e.g., a color display screen), automatic data entry means, such as a barcode scanner, manual data entry means (e.g., keyboard or touch screen), print means and wireless communication means. For example, portable compute device 23 may be in the form of a MC9000 series wireless, programmable compute device that is manufactured and sold by Symbol Technologies, Inc. of Holtsville, N.Y.

It should be noted that compute device 23 represents anywell-known handheld data collection terminal that can be programmed with user-specific software. Accordingly, it is to be understood that compute device 23 could be modified (e.g., to add/remove particular features) without departing from the spirit of the present invention.

As can be seen, each handheld compute device 23 is capable of wireless communication with a server 25 located at centralized hub 17. It is to be understood that centralized hub 17 may be situated in any location and is preferably managed by a corporation that specializes in inventory management services for small businesses, such as Rabbit Technology, Inc., of Framingham, Mass.

Server 25 in turn communicates with a compute device, such as a desktop computer, for each vendor 15 via any conventional communication network, such as the internet 27.

System 11 is shown comprising five distinct vendors 15-1, 15-2, 15-3, 15-4 and 15-5 (also identified herein as vendor A, vendor B, vendor C, vendor D and vendor E, respectively). However, it should be noted that system 11 is not limited to any particular number of vendors 15. Rather, it is to be understood that the number of vendors 15 participating in system 11 could be increased or decreased without departing from the spirit of the present invention.

### Look-Up Table for Cross-Referencing Vendors with each Customer

Server 25 is provided with a modifiable look-up table which cross-references which vendors 15 have established an authorized business relationship with each customer 13. Using the look-up table, server 25 limits electronic communication between only those vendors 15 and customers 13 who have an authorized business relationship in place, the relationship preferably being confirmed by each customer 13.

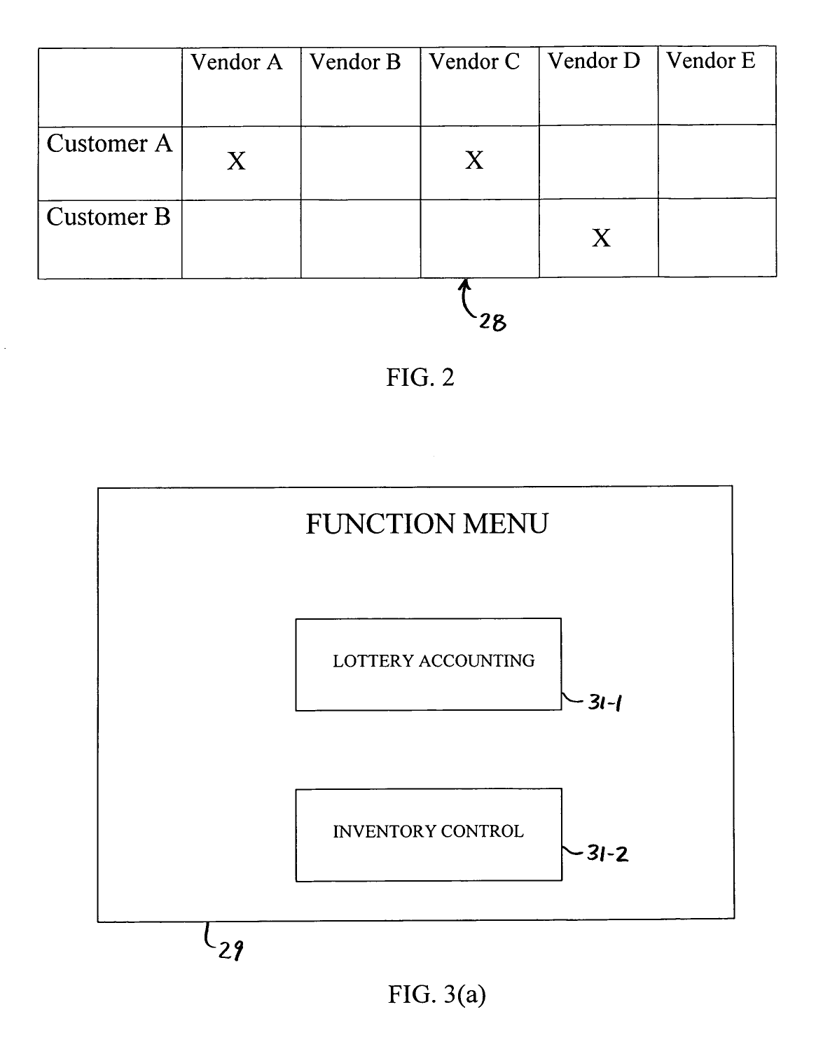

For example, referring now to FIG. 2, there is shown a sample look-up table which is retrievable by server 25, the look-up table being identified generally by reference numeral 28. As can be seen, look-up table 28 cross-references all customers 13 and vendors 15 that are participants in system 11. If an authorized business relationship exists between a particular customer 13 and vendor 15, look-up table 28 is correspondingly noted. In the present example, look-up table 28 recognizes that, for customer A, an authorized business relationship exists only with vendor A and vendor C (as denoted with an “X”). Similarly, look-up table 28 recognizes that, for customer B, an authorized business relationship exists only with vendor D. As a result, in accordance with look-up table 28, server 25 limits communication between (i) customer A and vendor A, (ii) customer A and vendor C, and (iii) customer B and vendor D.

As can be appreciated, the utilization of a look-up table by server 25 provides system 11 with a couple notable advantages.

As a first advantage, server 25 serves to protect each customer 13 from unwanted communications from vendors 15 with which customer 13 does not have an authorized business relationship.

As a second advantage, server 25 can utilize the look-up table to simplify the order placement process undertaken by each customer 13, as will be described further in detail below.

### Method of Placing a Supply Order

A novel method by which a customer 13 places a supply order to a vendor 15 is described herein. As part of the novel inventory management process, each customer is responsible for both (i) self-monitoring levels of its inventory 19 and (2) placing its own supply orders, when deemed necessary, to augment and/or maintain inventory levels. As noted in the background above, both of the aforementioned tasks are traditionally undertaken by sales representatives for each vendor. As a result, it is to be understood that the present method eliminates the need for vendor sales representatives and telephone operators, which is an object of the present invention.

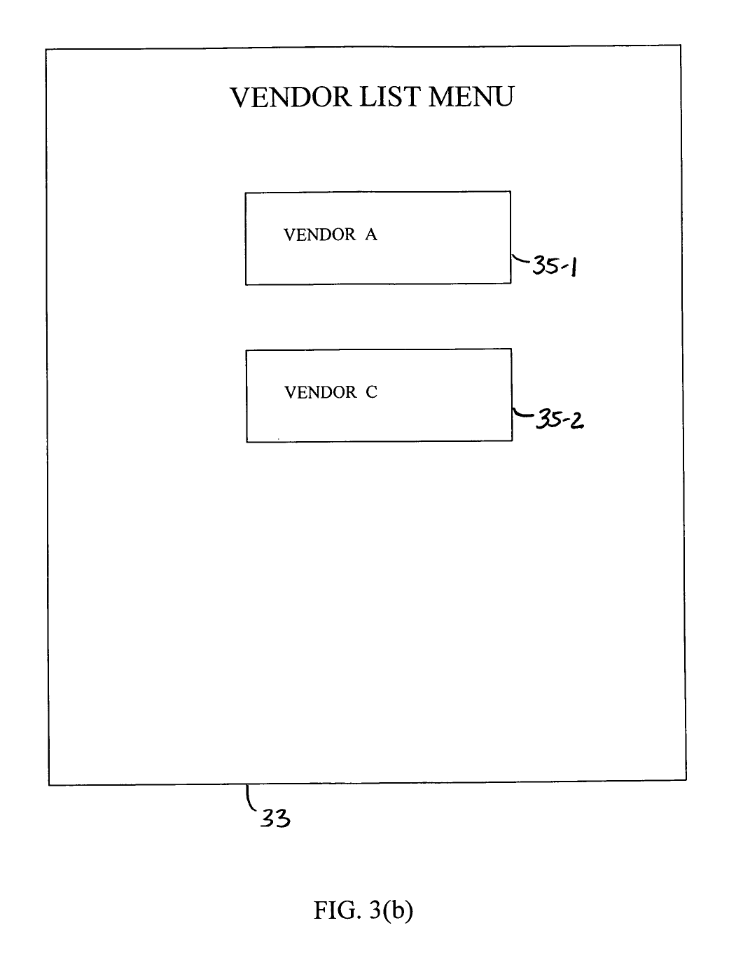

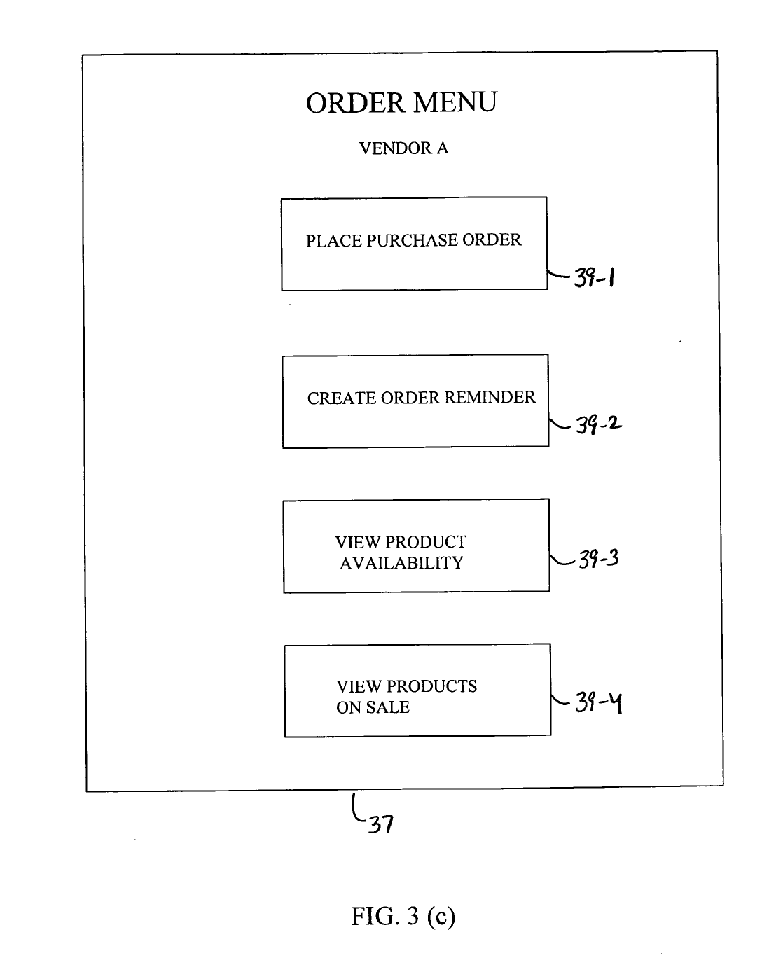

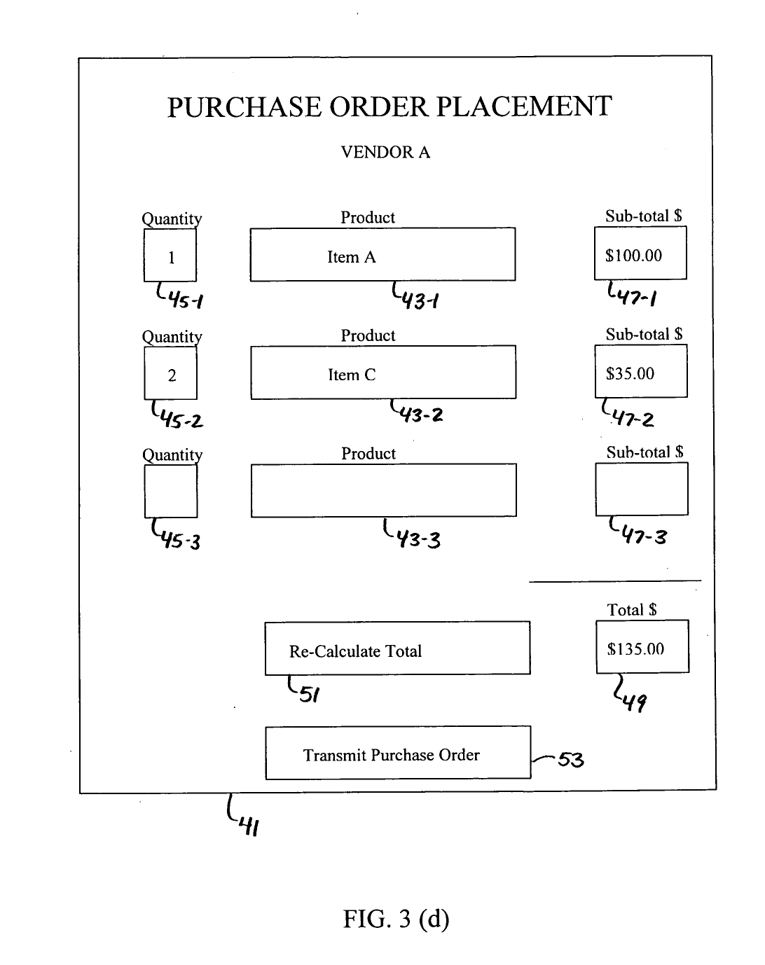

When a customer 13-1 deems that the placement of a supply order is necessary, customer 13-1 retrieves the main function menu on its handheld compute device 23 which is in turn linked with server 25. Referring now to FIG. 3(a), there is shown a sample user interface, or screen display, 29 of the main function menu. As can be seen, compute device 23 is preferably capable of performing a wide range of different tasks, such as lottery accounting 31-1 (as described in co-pending U.S. patent application Ser. No. 11/977,411, filed on Oct. 24, 2007, which is incorporated herein by reference) and inventory control 31-2.

Upon selecting the inventory control tab 31-2 on screen display 29 (e.g., using touch-screen technology), a vendor list menu is preferably provided on handheld compute device 23. Referring now to FIG. 3(b), there is shown a sample user interface, or screen display, 33 of the vendor list menu. As can be seen, server 25 cross-references look-up table 28 against the request for screen display 33 and, in turn, displays only the vendors 15 that have an authorized business relationship with customer 13-1. In this manner, look-up table 28 serves, inter alia, to greatly simplify the ordering process for 13-1 since it is conceivable that hundreds of different vendors 15 could be participants in system 11 at any given time. In the present example, customer 13-1 is provided a vendor list screen display 33 which includes a tab 35-1 for vendor A and a tab 35-2 for vendor C.

After selecting a particular vendor 15 (e.g., vendor A), a main order menu associated with the vendor 15 is provided on handheld compute device 23. Referring now to FIG. 3(c), there is shown a sample screen display 37 that displays a series of functionality tabs 39 that are associated with the selected vendor 15 (e.g., vendor A). Specifically, sample screen display 37 includes, but is not limited to: (1) a purchase order placement function tab 39-1 (i.e., for the placement of a standard purchase order with the designated vendor 15), an order reminder function 39-2 (i.e., for creating and/or viewing a purchase order reminderfrom the vendor 15 which is established using customer-defined parameters), (3) a product availability functionality tab 39-3 which displays, in near real-time, a complete list of products available for sale by the vendor 15, and (4) a sales product functionality tab 39-4 which displays a complete list of currently discounted (i.e., sales) products that are available by the vendor 15.

In order to execute a purchase order, customer 13 activates purchase order functionality tab 39-1 on screen display 37 which, in turn, extracts a detailed purchase order placement screen display 41, as seen most clearly in FIG. 3(d). On screen display 41, customer enters the identification code associated with the particular product which requires re-ordering within one of its product windows 43-1, 43-2 and 43-3. To facilitate in this process, it is to be understood that the identification code associated with each item may be input into windows 43 in an automated manner (e.g., by scanning a UPC barcode on the item using compute device 23). Once the identification code for each product is input, compute device 23 preferably searches a product database (e.g., linked with server 25 or stored internally in device 23) and displays the more familiar brand name associated with the product within each window 43. Having input the product name into windows 43-1, 43-2 and 43-3, the amount of each product is then input into corresponding quantity windows 45-1, 45-2 and 45-3, respectfully (e.g., using a keypad and/or touchscreen provided on compute device 23). Preferably, the product database linked with compute device 23 provides the current sales price of each item offered for sale by vendor 15. Using the price information, compute device 23 automatically calculates the sub-total for each product listed in the purchase order and displays the cost within sub-total windows 47-1, 47-2 and 47-3. In addition, compute device 23 automatically calculates the total cost associated with the purchase order (i.e., by adding the values provided within windows 47) and displays the total cost of the purchase order in a total window 49. If the customer 13 wishes to modify the purchase order, a re-calculation tab 51 can be activated to re-calculate the total displayed in window 49. Once customer 13 is satisfied with the particulars of the purchase order, the order is sent to the particular vendor 15 through hub 17 by activating a transmit purchase order tab 53 on display 41, thereby completing the order placing process. It should be noted that the purchase order may be sent to hub 17 using either (i) a wireless medium (as shown in FIG. 1) or (ii) a landline (e.g., by mounting compute device 23 in a cradle which is in turn connected to a computer with internet access).

### Notable Advantages Associated with System 11

The presence of centralized hub 17 provides system 11 with a number of notable advantages over traditional means for managing customer inventory.

As a first advantage, centralized hub 17 enables a broad spectrum of individual customers 13 to communicate with a plurality of distinct vendors 15 in a simplified, efficient and inexpensive manner. Specifically, by providing each customer 13 with a single compute device 23 that is configured to wirelessly communicate with server 25, a standardized means of communicating can be established between selective customers 13 and vendors 15. To the contrary, in the absence of a centralized hub 17, a customer 13 would require a direct link of communication with each vendor 15. Because traditional order placement means is not standardized throughout the industry, it is envisioned that a single customer 13 would require a separate, uniquely programmed communication device (e.g., a handheld computer) for every vendor 15 with which it has an authorized business relationship. As can be appreciated, requiring a vendor 15 to supply a compute device to each of its customers 13 would not only introduce a sizable cost component to vendor 15 but also significantly complicate the ordering process for each customer 13, both of which are highly undesirable.

As a second advantage, centralized hub 17 enables vendors 15 to routinely communicate with its entire customer base in a simplified manner. Specifically, because each vendor 15 is linked with hub 17 through internet 27, vendor 15 can habitually send important real-time information to hub 17 which is, in turn, wirelessly transmitted to the handheld device 23 for each customer 13 with which it has a relationship. For example, vendor 15 may routinely transmit at least some of the following information to its customers 13 via hub 17: (1) software updates for handheld device 23, (2) new products available for purchase, (3) purchase order reminders or other similar notifications, (4) items temporarily offered at a reduced price (i.e., sales products), and (5) product availability updates (i.e., real-time status of products in stock). As noted above, server 25 utilizes look-up table 28 to limit the transmittal of vendor information to only customers 13 with which vendor 15 has a customer-authorized relationship. In this manner, customers 13 are precluded from receiving large quantities of information from unauthorized vendors 15, which is highly desirable.

In addition to its role as the centralized means for regulating communication between a plurality of customers 13 and vendors 15, hub 17 is also preferably assigned at least some of the following responsibilities: (i) the purchase, replacement and storage of handheld compute devices 23 used in system 11, (ii) the distribution of compute devices 23 to customers 13, (iii) the maintenance of the hardware and software for handheld compute devices 23, and (iv) to the management, maintenance and storage of data used in system 11 (e.g., look-up table 28, vendor updates and sales offerings, etc.). To compensate hub 17 for the costs associated with the services noted above, it is contemplated that each customer 13 and each vendor 15 pay centralized hub 17 a fee to participate in system 11.

As an example, it is proposed that each vendor 15 pay centralized hub 17 a periodic fee (i.e., a membership fee) for the services provided above. It is to be understood that the fee may be adjusted based upon, among other things, (i) the number of customers 13 which are linked with vendor 15 during a specified period and/or (ii) the volume of data delivered from vendor 15 to each of its customers 13 via hub 17 during a specified period.

As another example, it is proposed that each customer 13 pay centralized hub 17 a periodic fee (i.e., a membership fee) for the services provided above. It is to be understood that the fee may be adjusted based upon, among other things, (i) the number of handheld compute devices 23 supplied, and/or (ii) the range of services provided to customer 13 by hub 17 (e.g., lottery accounting, inventory control, etc.).

The embodiment shown in the present invention is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A system for managing inventory, the system comprising:
(a) a plurality of customers, each customer comprising an inventory of items,
(b) a plurality of vendors, each vendor comprising at least one product available for purchase by the plurality of customers, and
(c) a server in electronic communication with the plurality of customers and the plurality of vendors,
(d) wherein the server is provided with a modifiable lookup table which cross-references which of the plurality of vendors has an authorized business relationship with each customer, the server limiting electronic communication between the plurality of customers and plurality of vendors to only those relationships set forth as authorized on the lookup table.

2. The system as claimed in claim 1 wherein at least one customer places a purchase order for a product from at least one vendor through the server.

3. The system as claimed in claim 2 wherein the at least one customer comprises a compute device which is in electronic communication with the server.

4. The system as claimed in claim 3 wherein the compute device is handheld and programmable in nature.

5. The system as claimed in claim 4 wherein the at least one customer places the purchase order using the compute device.

6. The system as claimed in claim 5 wherein the compute device wirelessly transmits the purchase order to the server.

7. The system as claimed in claim 3 wherein the compute device is programmed to include a first user interface which displays a list of authorized vendors for the at least one customer, the server limiting the list displayed on the first user interface to only those vendors set forth as authorized on the lookup table.

8. The system as claimed in claim 7 wherein the compute device is programmed to include a second user interface which displays a list of products available for purchase by one of the list of authorized vendors provided on the first user interface.

9. The system as claimed in claim 8 wherein the second user interface provides the list of products available for purchase by the at least one vendor in near-real time.

10. The system as claimed in claim 3 wherein one of the plurality of vendors transmits information to the server.

11. The system as claimed in claim 10 wherein the server transmits the information to each of the plurality of customers with which the one of plurality of vendors has an authorized business relationship as set forth on the lookup table.

12. The system as claimed in claim 11 wherein the server transmits the information to a compute device for each customer with which the one of the plurality of vendors has an authorized business relationship.

13. The system as claimed in claim 12 wherein the one of the plurality of vendors transmits a purchase order reminder for one of the plurality of customers to the server.

14. The system as claimed in claim 13 wherein the server cross-references the purchase order reminder against the look-up table, the server transmitting the purchase order reminder to the one of the plurality of customers if the relationship between the one of plurality of customers and the one of the plurality of vendors is deemed as authorized.
